(19) United States
(12) Patent Application Publication
(10) Pub. No.: US 2008/0129635 A1
(43) Pub. Date: Jun. 5, 2008

(54) METHOD OF OPERATING A PATCH ANTENNA IN A HIGHER ORDER MODE

(75) Inventors: Nuttawit Surittikul, Ann Arbor, MI (US); Kwan-ho Lee, Ann Arbor, MI (US); Wladimiro Villarroel, Worthington, OH (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: AGC AUTOMOTIVE AMERICAS R&D, INC., Ypsilanti, MI (US)

(21) Appl. No.: 11/739,885

(22) Filed: Apr. 25, 2007

Related U.S. Application Data
(60) Provisional application No. 60/868,436, filed on Dec. 4, 2006.

(51) Int. Cl. H01Q 1/38; H01Q 1/50

(52) U.S. Cl. 343/858; 343/700 MS

(57) ABSTRACT

The invention provides a method of operating a patch antenna having a radiating element. The radiating patch is excited and generates a circularly polarized radiation beam solely in a higher order mode at a desired frequency. This allows for the radiating element to have a small surface area with the radiating beam tilted away from an axis perpendicular to the radiating element. Thus, the patch antenna provides a relatively small footprint and excellent RF signal reception from SDARS satellites at low elevation angles.

### CROSS REFERENCE TO RELATED APPLICATION

This application claims the benefit of U.S. Provisional Application No. 60/868,436, filed Dec. 4, 2006.

### BACKGROUND OF THE INVENTION

1. Field of the Invention

The subject invention relates to a method of operating a patch antenna.

2. Description of the Related Art

Satellite Digital Audio Radio Service (SDARS) providers use satellites to broadcast RF signals, particularly circularly polarized RF signals, back to receiving antennas on Earth. The elevation angle between a satellite and an antenna is variable depending on the location of the satellite and the location of the antenna. Within the continental United States, this elevation angle may be as low as 20° from the horizon. Accordingly, specifications of the SDARS providers require a relatively high gain at elevation angles as low as 20° from the horizon.

SDARS reception is primarily desired in vehicles. SDARS compliant antennas are frequently bulky, obtuse-looking devices mounted on a roof of a vehicle. SDARS compliant patch antennas typically have a square-shaped radiating element with sides about equal to ½ of the effective wavelength of the SDARS RF signal. These patch antennas typically also include a square-shaped ground plane that has a surface area larger than that of the radiating element. When the patch antenna is disposed on a window of the vehicle, the large “footprint” defined by the radiating element and ground plane often obstructs the view of the driver. Therefore, these patch antennas are not typically disposed on the windows of the vehicle.

Various methods of operating patch antennas to receive RF signals are well known in the art. Examples of such methods are disclosed in the U.S. Pat. No. 4,887,089 (the '089 patent) to Shibata et al. and U.S. Pat. No. 6,252,553 (the '553 patent) to Soloman.

The '089 patent discloses a method of operating a patch antenna having a radiating element. The method includes the step of feeding a signal to the radiating element at either a first port or a second port, utilizing a switching mechanism. The method also includes the step of generating a horizontally polarized (i.e., linearly polarized) radiation beam in a higher order mode. The patch antenna of the '089 patent does not generate a circularly polarized radiation beam and therefore is of little value in the reception of circularly polarized RF signals broadcast from satellites.

The '553 patent also discloses a method of operating a patch antenna having a radiating element. The method includes the step of shifting the phase of a base signal to produce at least one phase-shifted electromagnetic signal. The method continues by feeding the base signal and the phase-shifted signal to side feed ports of the radiating element and feeding the base signal to a central feed port of the radiating element. The method also includes the step of generating a circularly-polarized radiation beam in a fundamental mode and a higher order mode. The patch antenna of the '553 patent does not generate the circularly polarized radiation beam solely in a higher order mode. As a result, the surface area defined by the radiation element is significantly large.

There remains an opportunity to introduce a method of operating a patch antenna that aids in the reception of a circularly polarized RF signal from a satellite at a low elevation, especially when the patch antenna is disposed on an angled pane of glass, such as the window of a vehicle. There also remains an opportunity to introduce a method of operating a patch antenna which significantly reduces the required “footprint” of the antenna's radiating element when compared to other prior art patch antennas.

### SUMMARY OF THE INVENTION AND ADVANTAGES

The invention provides a method of operating a patch antenna at a desired frequency. The patch antenna includes a radiating element formed of a conductive material. The method includes generating a circularly polarized radiation beam solely in a higher order mode at the desired frequency by exciting the radiating element.

By generating the circularly polarized radiation beam solely in a higher order mode the maximum gain of the radiation beam is tilted away from an axis perpendicular to the radiating element. This tilting-effect is very beneficial when attempting to receive the circularly polarized RF signals from a satellite at a low elevation angle. Furthermore, by generating the circularly polarized radiation beam solely in a higher order mode, the dimensions of the radiating element are much smaller than many prior art radiating elements. This is very desirable to automotive manufacturers and suppliers who wish to mount the radiating element on a window of a vehicle and still maintain good visibility for a driver through the glass.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view a vehicle with a patch antenna supported by a pane of glass of the vehicle;

FIG. 2 is a perspective view of the antenna showing a radiating element, a first dielectric layer, a feed network, a second dielectric layer, and a ground plane;

FIG. 3 is a cross-sectional view of a preferred embodiment of the antenna with the radiating element disposed on the pane of glass and electromagnetic coupling of a feed line network to the radiating element;

FIG. 4 is an electrical schematic block diagram of the preferred embodiment of the antenna showing the radiating element, a receiver, a low noise amplifier, a first phase shift circuit, and a plurality of feed lines;

FIG. 5 is a chart showing a pattern of a left hand circularly polarized radiation beam resulting from operation of the preferred embodiment of the antenna;

FIG. 6 is a cross-sectional view of the preferred embodiment of the antenna taken along line 6-6 of FIG. 3 showing a feed line network disposed on the second dielectric layer;

FIG. 7 is a cross-sectional view of an alternative embodiment of the antenna with the ground plane disposed between the dielectric layers and direct electrical connection of the feed line network to the radiating element; and

FIG. 8 is a bottom view of the alternative embodiment of the antenna taken along line 8-8 of FIG. 7 and showing the feed line network disposed on the second dielectric layer.

### DETAILED DESCRIPTION OF THE INVENTION

Referring to the Figures, wherein like numerals indicate corresponding parts throughout the several views, a patch antenna 20 and associated method of operation are provided.

The method of operation of the antenna 20 is described herein with reference to a preferred structural embodiment for the antenna 20. Those skilled in the art realize that the method may be practiced with other antennas of alternative embodiments that differ in design and construction from that of the preferred embodiment. Therefore, the structure of the antenna 20 recited herein should not be read as limiting.

In the preferred embodiment, the antenna 20 is utilized to receive a circularly polarized radio frequency (RF) signal from a satellite. Specifically, the antenna 20 may be utilized to receive a left-hand circularly polarized (LHCP) RF signal like those produced by a Satellite Digital Audio Radio Service (SDARS) provider, such as XM® Satellite Radio or SIRIUS® Satellite Radio. However, those skilled in the art understand that the antenna 20 may also receive a right-hand circularly polarized (RHCP) RF signal. Furthermore, in addition to receiving the LCHP and/or RHCP RF signals, the antenna 20 may also be used to transmit the circularly polarized RF signal. The antenna 20 will be described hereafter mainly in terms of receiving the LHCP RF signal, but this should not be read as limiting in any way.

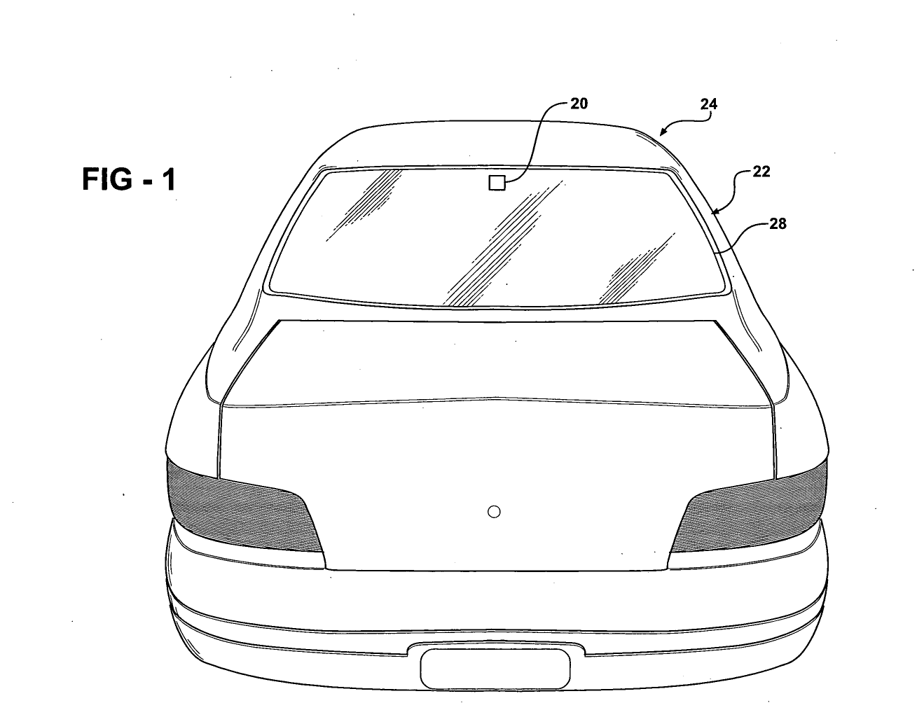

Referring to FIG. 1, the antenna 20 is preferably integrated with a window 22 of a vehicle 24. This window 22 may be a part of a roof (such as a glass roof), a rear window (backlite), a front window (windshield), or any other window of the vehicle 24. Those skilled in the art realize that the antenna 20 as described herein may be located at other positions on the vehicle 24, such as on a sheet metal portion like the roof of the vehicle 24 or a side mirror of the vehicle 24. The antenna 20 may also be implemented in other situations completely separate from the vehicle 24, such as on a building or integrated with a radio receiver. The rear window 22 and the windshield are typically each disposed in the vehicle 24 at an angle, such that they define a surface that is not parallel to the ground (i.e., the surface of the Earth). Therefore, the antenna 20 disposed on these types of windows 22 are also not parallel to the ground.

The window 22 preferably includes at least one pane of glass 28. The pane of glass 28 is preferably automotive glass and more preferably soda-lime-silica glass, which is well known for use in panes of glass of vehicles 24. The pane of glass 28 functions as a radome to the antenna 20. That is, the pane of glass 28 protects the other components of the antenna 20, as described in detail below, from moisture, wind, dust, etc. that are present outside the vehicle 24. The pane of glass 28 defines a thickness between 1.5 and 5.0 mm, preferably 3.1 mm. The pane of glass 28 also has a relative permittivity between 5 and 9, preferably 7. Of course, the window 22 may include more than one pane of glass 28. Those skilled in the art realize that automotive windows 22, particularly windshields, include two panes of glass sandwiching a layer of polyvinyl butyral (PVB).

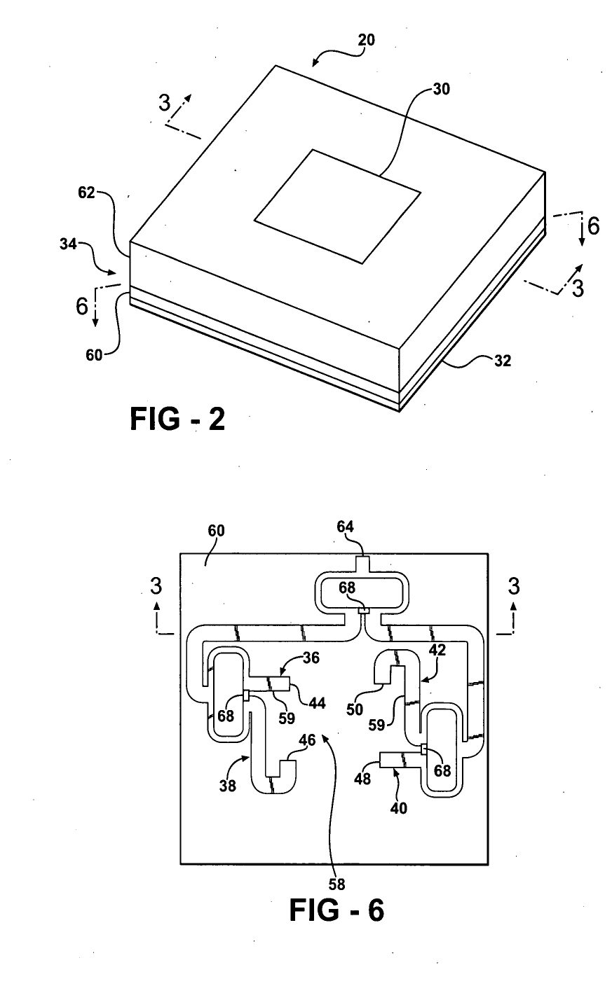

Referring now to FIG. 2, the antenna 20 includes a radiating element 30 formed of an electrically conductive material described additionally below. The radiating element 30 is also commonly referred to by those skilled in the art as a “patch” or a “patch element”. The radiating element 30 of the preferred embodiment defines a generally rectangular shape, specifically a square shape. Each side of the radiating element 30 measures about ¼ of an effective wavelength λ of the RF signal to be received by the antenna 20. RF signals transmitted by SDARS providers typically have a frequency from 2.32 GHz to 2.345 GHz. Specifically, XM Radio broadcasts at a center frequency of 2.338 GHz. Therefore, each side of the radiating element 30 measures about 24 mm. However, those skilled in the art realize alternative embodiments where the radiating element 30 defines alternative shapes and sizes based on the desired frequency and other considerations.

The antenna 20 also includes a ground plane 32 formed of an electrically conductive material such as, but not limited to, copper. The ground plane 32 is disposed substantially parallel to and spaced from the radiating element 30. It is preferred that the ground plane 32 also defines a generally rectangular shape, specifically a square shape. In the preferred embodiment, the ground plane 32 measures about 60 mm×60 mm. However, the ground plane 32 may be implemented with various shapes and sizes.

At least one dielectric layer 34 is disposed between the radiating element 30 and the ground plane 32. Said another way, the at least one dielectric layer 34 is sandwiched between the radiating element 30 and the ground plane 32. The preferred embodiment of the at least one dielectric layer 34 is described in greater detail below.

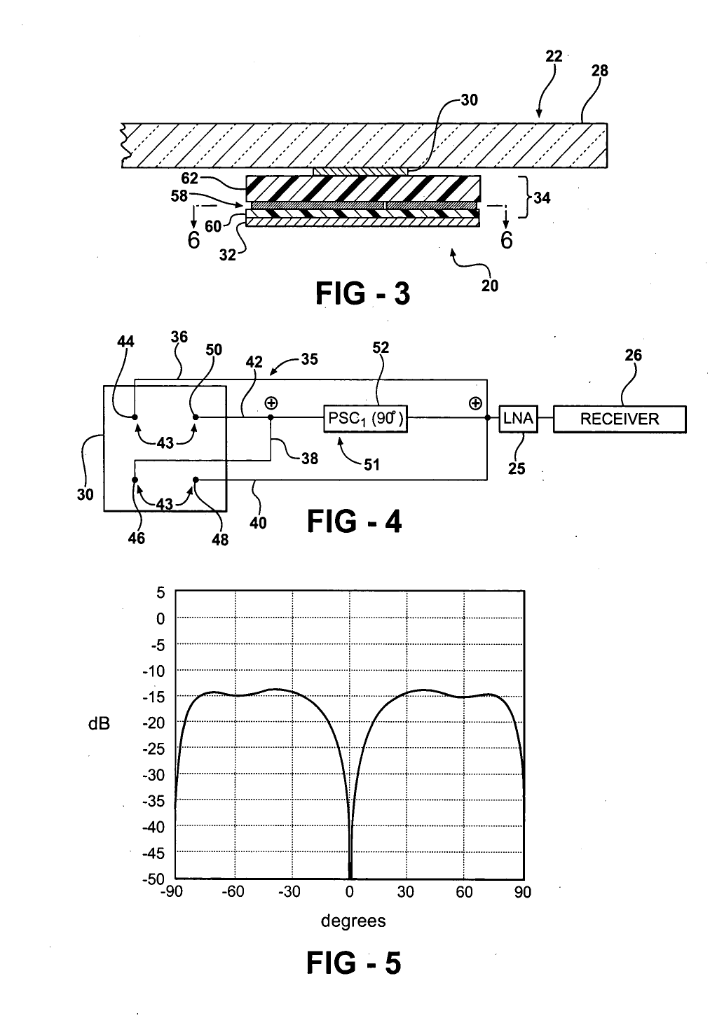

In the preferred embodiment, as shown in FIG. 3, the pane of glass 28 of the window 22 supports the radiating element 30. The pane of glass 28 supports the radiating element 30 by the radiating element 30 being adhered, applied, or otherwise connected to the pane of glass 28. Preferably, the radiating element 30 comprises a silver paste as the electrically conductive material disposed directly on the pane of glass 28 and hardened by a firing technique known to those skilled in the art. Alternatively, the radiating element 30 could comprise a flat piece of metal, such as copper or aluminum, adhered to the pane of glass 28 using an adhesive.

Referring now to FIG. 4, the patch antenna 20 of the preferred embodiment also includes a plurality of feed lines 35. Each feed line 35 is electrically connected to the radiating element 30 at a feed port 43. Each feed port 43 is defined as the end point, or terminus, of each feed line 35. In the preferred embodiment, the feed ports 43 are not in contact with the radiating element 30. Instead, the electrical connection is produced by an electromagnetic coupling between the feed port 43 and the radiating element 30. However, in alternative embodiments, the feed ports 43 (and accordingly, the feed lines 35) may come into direct contact with the radiating element 30.

In the preferred embodiment, the antenna 20 is implemented with four feed lines 36, 38, 40, 42 electrically connected to the radiating element 30 at four feed ports 44, 46, 48, 50. Specifically, a first feed line 36 is electrically connected to the radiating element 30 at a first feed port 44, a second feed line 38 is electrically connected to the radiating element 30 at a second feed port 46, a third feed line 40 is electrically connected to the radiating element 30 at a third feed port 48, and a fourth feed line 42 is electrically connected to the radiating element 30 at a fourth feed port 50.

The feed ports 44, 46, 48, 50 of the preferred embodiment are disposed with relationship to one another such that the feed ports 44, 46, 48, 50 define corners of a square shape. Of course, the square shape is merely a hypothetical construct for easily showing the physical relationship between the feed ports 44, 46, 48, 50. Those skilled in the art realize that the feed ports 44, 46, 48, 50 of the preferred embodiment also define a circle shape with each feed port 44, 46, 48, 50 about equidistant along a periphery of the circle shape from adjacent feed ports 44, 46, 48, 50 and a diameter equal to the diagonals of the square shape. For ease in labeling, the feed ports 44, 46, 48, 50 are assigned sequentially counter-clockwise around the square or circle. For example, if the feed port 43 in the upper, left-hand corner of the square is the first feed port 44, then the second feed port 46 is in the lower, left-hand corner, the third feed port 48 is in the lower, right-hand corner, and the fourth feed port 50 is in the upper, right-hand corner.

The antenna 20 of the preferred embodiment also includes at least one phase shift circuit 51 for shifting the phase of a base signal. In the preferred embodiment, the base signal is provided to a low noise amplifier 25 and/or a receiver 26 from the antenna 20. Of course, in other embodiments, in which the antenna 20 is used to transmit, the base signal is provided by a transmitter (not shown). The base signal, since it is not phase shifted, may be referred to as being offset by zero degrees (0°).

In the preferred embodiment, as shown in FIG. 4, the at least one phase shift circuit 51 is implemented as a first phase shift circuit 52. The first phase shift circuit 52 shifts the base signal by about ninety degrees (90°) to produce a first phase-shifted signal. Those skilled in the art realize that the 90° phase shift could vary by up to ten percent with little impact on overall performance. The first phase shift circuit 52 is electrically connected to the second feed line 38 and the fourth feed line 42, and thus, provides the first phase-shifted signal (90°) to the second feed port 46 and the fourth feed port 50. As a result, the first phase-shifted signal (90°) is applied at opposite corners of the square. The LNA 25 is electrically connected to the first feed line 36 and the third feed line 40. Thus, the base signal (0°) is applied to the first feed port 44 and the third feed port 48, also at opposite corners of the square. Application of the base signal and first phase-shifted signal in this manner produces a circularly polarized radiation beam. Those skilled in the art will realize alternate embodiments to produce the circularly polarized radiation beam using different configurations of phase shift circuits 51.

As stated above, the subject invention provides a method of operating the patch antenna 20. This method includes the step of generating a circularly polarized radiation beam solely in a higher order mode at the desired frequency by exciting the radiating element 30. Said another way, the circularly polarized radiation beam is not generated in a fundamental mode, but only in a higher order mode. That is, the operating mode of the antenna 20 consists of a higher order mode. Preferably, the higher order mode is a transverse magnetic mode. More preferably, the higher order mode is a TM22 mode. However, those skilled in the art realize that the other higher order modes besides the TM22 mode may achieve acceptable results. Furthermore, in other embodiments, the radiation beam may also be generated in both the higher order and fundamental modes.

Generating the circularly polarized radiation beam solely in a higher order mode is accomplished due to the application of the base signal and the phase-shifted signals to the radiating element 30 along with the spacing of the feed ports 44, 46, 48, 50 with respect to one another. In the preferred embodiment, each side of the square defined by the feed ports 44, 46, 48, 50 measures about ⅙ of the effective wavelength of the resulting radiation beam. Said another way, each feed port 44, 46, 48, 50 is separated from two other adjacent feed ports 44, 46, 48, 50 by about ⅙ of the effective wavelength. The spacing between the feed ports 44, 46, 48, 50 is dependent on the desired operating frequency of the antenna 20, which, in the preferred embodiment, is about 2.338 GHz. Within the teaching of the present invention, the dimensions may be modified by one skilled in the art for alternative operating frequencies. Furthermore, the effective wavelength depends on the window 22 and the dielectric layers 34. As such, the permittivity and thickness of these elements has an effect on the size of the patch as is appreciated by those skilled in the art.

By generating the circularly polarized radiation beam solely in a higher order mode, a null is established in the LHCP radiation beam at an axis perpendicular to the radiating element 30. Said another way, the pattern of the radiation beam shows a null in the broadside direction, as is shown in FIG. 5. More importantly, the maximum gain of the LHCP radiation beam is about 40-50 degrees offset the axis perpendicular to the radiating element 30. Thus, the LHCP radiation beam is “tilted” (or “steered”.) This tilting-effect is very beneficial when attempting to receive the LHCP RF signals from a satellite at a low elevation angle, e.g., an XM radio satellite. Furthermore, by generating the circularly polarized radiation beam solely in a higher order mode, the dimensions of the radiating element 30 are much smaller than many prior art radiating elements 30. This is very desirable to automotive manufacturers and suppliers who wish to lessen the amount of obstruction on the windows 22 of the vehicle 24. Additionally, the use of less conductive material in the radiating element 30 may also reduce manufacturing costs and enhance and improve aesthetics.

The method of operating the patch antenna 20 also includes the step of shifting the phase of a base signal to produce at least one phase-shifted signal. This may be accomplished, as described above, with one or more phase shift circuits 51. In the preferred embodiment, this step includes shifting the phase of the base signal by 90 degrees to produce a first phase-shifted signal.

The method of operating the patch antenna 20 may also include the step of feeding the base signal to the radiating element 30 through at least one of the plurality of feed ports 44, 46, 48, 50 and feeding the at least one phase-shifted signal to the radiating element 30 through at least one of the other feed ports 44, 46, 48, 50. In the first implementation, the step includes feeding the base signal through the first and third feed ports 44, 48 and feeding the first phase-shifted signal through the second and fourth feed ports 46, 50. In the second implementation, the step includes feeding the base signal through the first feed port 44, feeding the first phase-shifted signal through the second feed port 46, feeding the second phase-shifted signal through the third feed port 48, and feeding the third phase-shifted signal through the fourth feed port 50.

Referring again to FIG. 2, in the preferred embodiment, the at least one dielectric layer 34 is implemented as a first dielectric layer 60 and a second dielectric layer 62. The first dielectric layer 60 is in contact with the ground plane 32. The second dielectric layer 62 is in contact with the radiating element 30. Preferably, the first and second dielectric layers 60, 62 are at least partially in contact with one another. The width of the dielectric layers 60, 62 is based, in part, on the dielectric constant of the dielectric layers 60, 62. Preferably, the dielectric constant of both dielectric layers 60, 62 is about 4.5. The width of the second dielectric layer 62 is about 1/20 of the effective wavelength and the width of the first dielectric layer 60 is about 1/60 of the effective wavelength.

The patch antenna 20 preferably includes a feed line network 58 formed of conductive strips 59 as shown in FIG. 6. The conductive strips 59 act as the feed lines 36, 38, 40, 42 and feed line ports 44, 46, 48, 50 described above. The feed line network 58 also defines an input port 64 which may be electrically connected to the receiver 26 and/or the LNA 25.

In the preferred embodiment, where the feed lines 36, 38, 40, 42 are electromagnetically coupled to the radiating element 30, the feed line network 58 is sandwiched between the first and second dielectric layers 60, 62. The conductive strips 59 of the feed line network 58 are disposed either on the first dielectric layer 60 or the second dielectric layer 62 at the junction of the dielectric layers 34. The conductive strips 59 may be etched on one of the dielectric layers 34 by processes known to those skilled in the art.

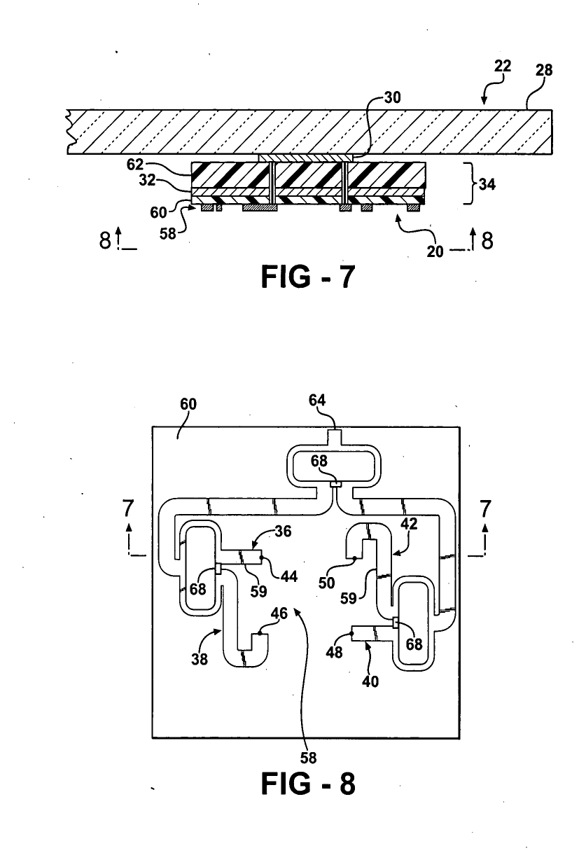

FIGS. 7 and 8 show an alternative embodiment where there is a direct connection between the feed lines 36, 38, 40, 42 and the radiating element 30. In this alternative embodiment, the ground plane 32 is sandwiched between the first and second dielectric layers 60, 62. The feed line network 58 is disposed on the first dielectric layer 60 on the opposite side from the feed line network 58. A plurality of pins 64 electrically connects the feed lines to the ground plane 32. Passage holes (not numbered) are defined in the ground plane 32 to prevent an electrical connection between the feed lines 36, 38, 40, 42 and the ground plane 32.

In both the preferred and alternative embodiments, the feed line network 58 is also utilized to shift the phase of a signal applied to the feed lines 36, 38, 40, 42, thus, acting as the phase shift circuits 51 described above. This phase shifting is accomplished due to the inductive and capacitive properties of the conductive strips 59 of the feed line network 58. The inductive and capacitive properties of the conductive strips 59 are determined by the impedance and length of each conductive strip 59. The impedance of each conductive strip 59 is determined by the frequency of operation, the width of each conductive strip 59, the dielectric constant of the first dielectric layer 60, and the distance between the conductive strips 59 and the ground plane 32. In the described embodiments, a conductive strip 59 width of about 1/60 of the effective wavelength yields an impedance of about 70.71 ohms and a width of about 1/35 of the effective wavelength yields an impedance of about 50 ohms.

The feed line network 58 shown in FIG. 6 implements the 0°, 90°, 0°, and 90° phase shifts. As can be seen, the conductive strips 59 form divergent paths which alternate between the various widths. Resistors 68 electrically connect between the divergent paths to ensure that an equal amount power is carried to or from each feed line port 44, 46, 48, 50. Those skilled in the art realize that the feed line network 58 could be designed to perform other phase shifts or in a manner that does not perform any phase shifts.

Those skilled in the art realize that many of the Figures are not drawn to scale. This is particularly evident in the cross-sectional representations of the various embodiments of the antenna 10 in FIGS. 3 and 7. Particularly, in these Figures, the width of the electrically conductive components, such as the radiating element 30, the ground plane 32, and the feed line network 58, is exaggerated such that it may be seen from the cross-sectional view. Those skilled in the art also realize that the width of these electrically conductive components may be much less than 1 mm and therefore difficult to perceive from an actual cross-sectional view of the antenna.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A method of operating a patch antenna at a desired frequency, the patch antenna including a radiating element formed of a conductive material, said method comprising:
generating a circularly polarized radiation beam solely in a higher order mode at the desired frequency by exciting the radiating element.

2. A method as set forth in claim 1 wherein the higher order mode is further defined as a transverse magnetic mode.

3. A method as set forth in claim 1 wherein the higher order mode is further defined as a TM22 mode.

4. A method as set forth in claim 1 further comprising the step of producing a maximum gain in the radiating beam at an angle at least 20 degrees offset from an axis perpendicular to the radiating element.

5. A method as set forth in claim 1 further comprising the step of producing a maximum gain in the radiating beam at an angle at least 35 degrees offset from an axis perpendicular to the radiating element.

6. A method as set forth in claim 1 further comprising the step of establishing a null in the radiating beam along an axis perpendicular to the radiating element.

7. A method as set forth in claim 1 further comprising the step of shifting the phase of a base signal to produce at least one phase-shifted signal.

8. A method as set forth in claim 7 wherein the patch antenna further includes a plurality of feed lines electrically connected to the radiating element, each feed line electrically connected to the radiating element at a feed port, and further comprising the step of feeding the base signal to the radiating element through at least one of the plurality of feed ports and the at least one phase-shifted signal to the radiating element through at least one of the other feed ports.

9. A method as set forth in claim 8 wherein said step of shifting the phase of the base signal to produce at least one phase-shifted signal is further defined as the step of shifting the phase of the base signal by 90 degrees to produce a first phase-shifted signal.

10. A method as set forth in claim 9 wherein the plurality of feed lines is further defined as a first feed line electrically connected to said radiating element at a first feed port, a second feed line electrically connected to said radiating element at a second feed port, a third feed line electrically connected to said radiating element at a third feed port, and a fourth feed line electrically connected to said radiating element at a fourth feed port, and wherein the feed ports define the corners of a square with the first feed port diagonally opposite the third feed port, and said step of feeding is further defined as the steps of feeding the base signal through the first and third feed ports and feeding the first phase-shifted signal through the second and fourth feed ports.
